(19) United States
(12) Patent Application Publication
(10) Pub. No.: US 2015/0076969 A1
(43) Pub. Date: Mar. 19, 2015

(54) ELECTRIC MACHINE STATOR WITH AXIAL VENTS

(71) Applicants: Daniel Lasorso, Norwood, OH (US); Nicholas G. Lang, Cincinnati, OH (US)

(72) Inventors: Daniel Lasorso, Norwood, OH (US); Nicholas G. Lang, Cincinnati, OH (US)

(73) Assignee: SIEMENS INDUSTRY, INC., Alpharetta, GA (US)

(21) Appl. No.: 14/030,105

(22) Filed: Sep. 18, 2013

(51) Int. Cl. H02K 1/20; H02K 9/02

(52) U.S. Cl. CPC H02K 1/20; H02K 9/02
USPC 310/60 A

(57) ABSTRACT

A stator of an electric machine is provided and includes laminations arranged to form a core packet. Each lamination is formed to define an annular array of teeth at an inner radial portion thereof and an annular array of annular sectors at an outer radial portion thereof.

### BACKGROUND OF THE INVENTION

The subject matter disclosed herein relates to an electric machine and, more particularly, to an electric machine stator with axial vents shaped as annular sectors.

In electric machines, a stator is normally formed to define a bore in which a rotor is rotatably supported. Rotation of the rotor can generate current in conductive elements disposed to extend through the stator when the electric machine is run in a generator mode. By contrast, current applied to such conductive elements can cause the rotor to rotate in a motor mode.

During operation of the electric machine in either the generator or motor mode, a large amount of heat can be generated in the conductive elements. This heat can lead to damage to the conductive elements, insulation systems, the stator or the rotor if the heat is not removed or the heated elements are not otherwise cooled. One way to remove heat and to cool the various elements in an electric machine is to form cooling or ventilation paths through the stator by which coolant, such as ambient air, is directed through or across heated parts, such as the conductive elements or the stator back iron.

Often, the cooling or ventilations paths are formed by the removal of material from the stator at the desired locations of the cooling or ventilation paths. Doing so results in an increase in flux density around the area of the removed material. However, saturation exhibits a non-linear thresholding effect, where the sensitivity of a region to change is dependent on the flux density in that region. Moreover, the initial distribution of flux density is dependent on the pole count and bar and slot arrangements and geometries.

### BRIEF DESCRIPTION OF THE INVENTION

According to one aspect of the invention, a stator of an electric machine is provided and includes laminations arranged to form a core packet. Each lamination is formed to define an annular array of teeth at an inner radial portion thereof and an annular array of annular sectors at an outer radial portion thereof.

According to another aspect of the invention, a stator of an electric machine is provided and includes a stator core defining a bore in which a rotor is rotatably supportable. The stator core includes laminations arranged to form a core packet and each lamination includes an annular array of teeth at an inner radial portion thereof, the annular array of teeth defining an annular array of slots and an annular array of spokes at an outer radial portion thereof, the annular array of spokes defining an annular array of annular sectors.

According to another aspect of the invention, an electric machine is provided and includes a rotor and a stator defining a bore in which the rotor is rotatably supportable and operable in a motor or generator mode. The stator includes laminations respectively affixed adjacent to at least one or two neighboring laminations to form a core packet and each lamination is formed to define an annular array of teeth at an inner radial portion thereof and an annular array of annular sectors at an outer radial portion thereof.

According to yet another aspect of the invention, a method of assembling an electric machine is provided such that the electric machine includes a stator core having axial vents with a substantially consistent width between neighboring vents as well as between vents and an outer diameter of the stator core to thereby allow flux density to be adjusted while ensuring that all dimensions are able to be manufactured.

The method further limits the protrusion of the vents into the area surrounding the slots, which prevents saturation and improves performance, and provides that a number of vents and a number of slots are the same such that there will always be a path for flux lines entering or leaving a circumferential track around the outer diameter of the stator core regardless of the orientation of the field.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a radial view of an electric machine in accordance with embodiments;

FIG. 2 is an axial view of a portion of a lamination of FIG. 1;

FIG. 3 is an enlarged view of a group of annular sectors of FIG. 2;

FIG. 4 is an enlarged view of a corner of an annular sector in accordance with an alternative embodiment;

FIG. 5 is an enlarged view of a corner of an annular sector in accordance with an alternative embodiment; and

FIG. 6 is a radial view of an axial vent formed by the annular sectors of a plurality of adjacent laminations.

The detailed description explains embodiments of the invention, together with advantages and features, by way of example with reference to the drawings.

### DETAILED DESCRIPTION OF THE INVENTION

An electric machine is provided and includes a stator core with axial vents having shapes and sizes that provide a consistent width between neighboring vents as well as between vents and the outer diameter (OD) of the stator core. This configuration allows flux density to be adjusted while ensuring that all dimensions are able to be manufactured. It also limits the protrusion of the vents into the area around the slots, which prevents saturation and improves performance. Additionally, since a number of vents and a number of slots are the same, there will always be a path for flux lines entering or leaving the circumferential track around the OD regardless of the orientation of the field.

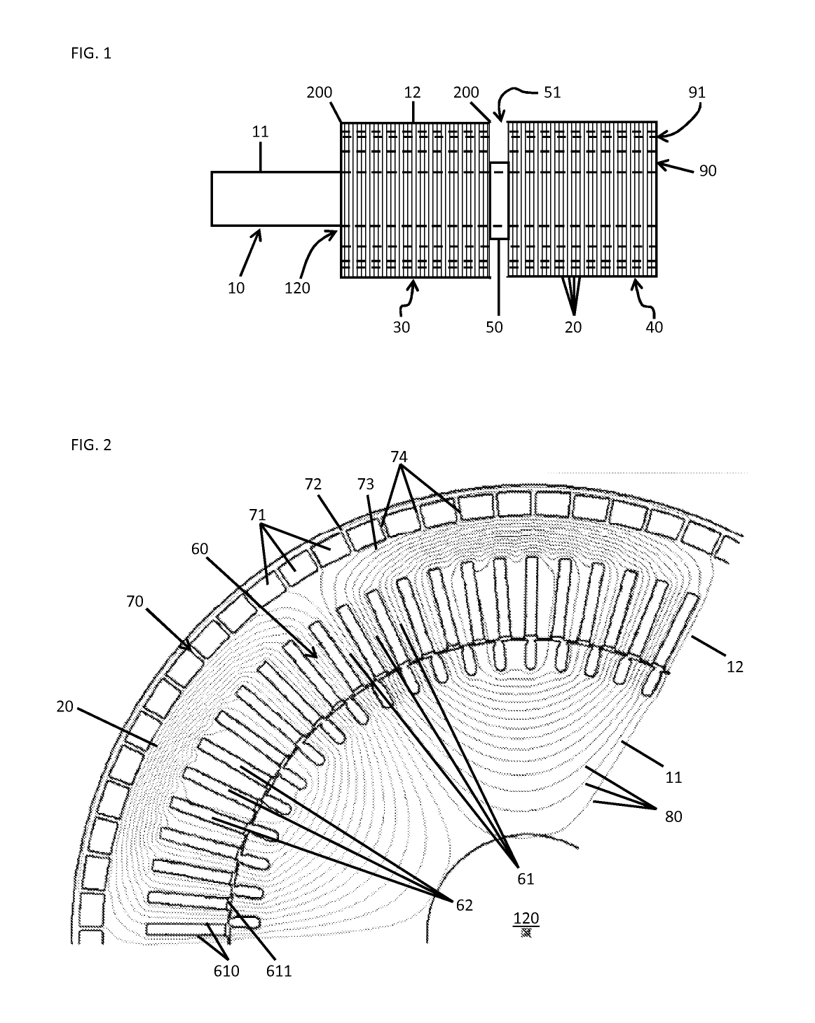

With reference to FIG. 1, an electric machine 10 is provided and configured to operate in a generator mode or a motor mode. The electric machine 10 includes a rotor 11 and a stator 12. The stator 12 is formed to define a bore 120 in which the rotor 11 is rotatably supportable. Rotation of the rotor 11 within the bore 120 can generate or induce flux that in turn induces a flow of current in conductive elements (to be described below), which are disposed to extend through the stator 12 in a predefined number of windings, when the electric machine 10 is operated in the generator mode. By contrast, current applied to the conductive elements can cause the rotor 11 to rotate when the electric machine 10 is operated in the motor mode.

The stator 12 is formed of a plurality of laminations 20 that are stacked between end plates 200. The end plates 200 are used to compress the laminations 20 and to provide support to end turns of the conductive elements. Each lamination 20 is formed from a relatively thin piece of sheet metal that is punched, stamped or otherwise cut into shape and then affixed adjacent to at least one or two neighboring and substantially similarly shaped and sized laminations. The bonding is achieved by an application of heat and pressure in accordance with various known methods.

With enough laminations 20 affixed adjacent to one another, the laminations 20 may form at least a first core packet 30 and a second core packet 40. The first and second core packets 30 and 40 may be separated from one another by a spacer 50 that is formed to define a radial vent 51.

The laminations 20 may be formed from metals or para-magnetic materials such as electrical steel or the like.

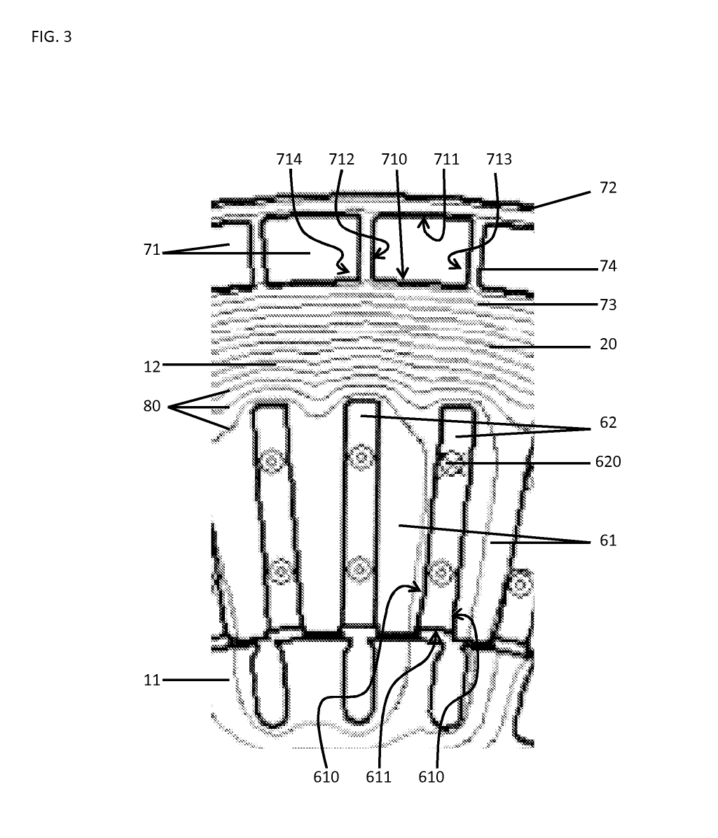

With reference to FIGS. 2 and 3, each of the laminations 20 has an inner radial portion 60 and an outer radial portion 70. At the inner radial portion 60, the laminations 20 are each formed to define an annular array of teeth 61. Each tooth 61 includes a pair of opposed radial sidewalls 610 that face an adjacent tooth 61 and a circumferential sidewall 611 that faces radial inwardly toward the bore 120. The annular array of teeth 61 thus defines a corresponding annular array of conductive element regions or slots 62 in which a plurality of conductive elements 620 are operably disposable.

The plurality of conductive elements 620 may be formed of a plurality of copper strands or a plurality of strands of another similarly conductive material. The strands are arranged in one or more columns in the slots 62 and have a current carrying capacity in accordance with design parameters. A layer of electrical insulation may be provided to surround each individual strand to thereby electrically insulate that strand from adjacent strands in the column or in adjacent columns

The electrical insulation surrounding each of the strands may be formed of a high thermal conductivity composite including one or more of polymers/resins, high thermal conductivity fillers and structural reinforcement materials such as E, S or S2 glass fibers, polyester fibers, Kevlar fibers or a like reinforcement material. Fillers made of boron nitride having cubic or hexagonal crystal structure or silica may be used. In this manner, heat transfer from each of the strands through the insulation is improved resulting in reduction of localized hot spot temperatures within individual strands and increased heat removal through axial teeth formation and axial vents (to be described below).

The plurality of conductive elements 620 may be connected or otherwise coupled to an electrical grid for providing alternating current to the grid. That is, when the electric machine 10 is operating in the above-noted generator mode, the electric machine converts mechanical energy embodied as a rotation of the rotor 11 to electrical energy by means of electromagnetic induction. In addition, the rotor 11 may also be connected to a grid, for example, in case of a doubly fed generator.

In accordance with embodiments, the plurality of conductive elements 620 may be wired with one another and with an external circuit so as to provide the stator 12 with a wiring configuration of a predefined or desired number of poles. As an example, as shown in FIG. 2, the wiring configuration may be that of a 6-pole wiring configuration.

Each of the laminations 20 is formed to define an annular array of annular sectors 71 at the outer radial portion 70 and proximate to an outer diameter of the laminations 20. Each annular sector 71 has an isosceles crowned-trapezoidal shape with a first circumferential arc-segment edge 710, a second circumferential arc-segment edge 711, which is parallel with and disposed radially outwardly from the first circumferential arc-segment edge 710 and first and second radial edges 712 and 713. The first radial edge 712 is oriented along a radial dimension of the lamination 20 and connects complementary ends of the first and second circumferential arc-segment edges 710 and 711. The second radial edge 713 is similarly oriented along the radial dimension of the lamination 20 and connects the opposite complementary ends of the first and second circumferential arc-segment edges 710 and 711. The first and second radial edges 712 and 713 are angled with respect to each other at a predefined radial angle measured at a rotational axis of the rotor 11.

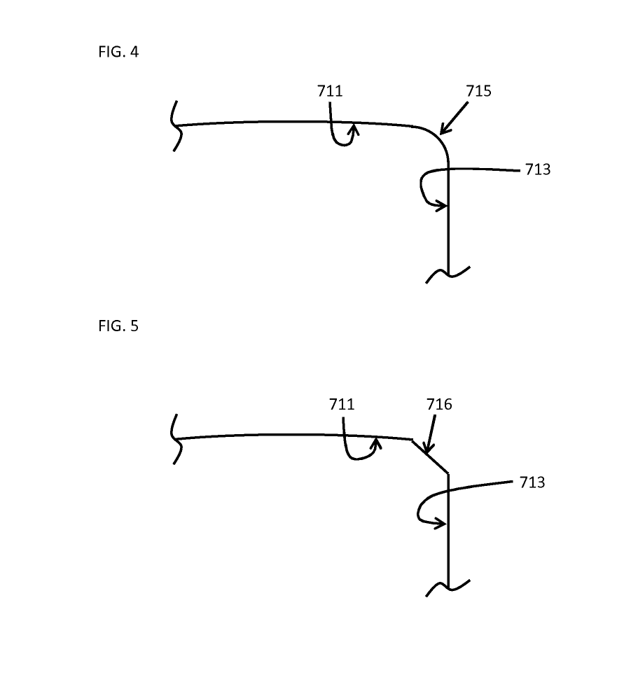

With reference to FIGS. 3, 4 and 5, the first and second circumferential arc-segment edges 710 and 711 and the first and second radial edges 712 and 713 may be formed such that one or more of the annular sectors 71 has one or more angular corners 714 (see FIG. 3) or one or more rounded corners 715 (see FIG. 4). Alternatively or additionally, the first and second circumferential arc-segment edges 710 and 711 and the first and second radial edges 712 and 713 may be formed such that one or more of the annular sectors 71 has one or more chamfered corners 716 (see FIG. 5).

In order to define the shape of the annular sectors 71, the laminations 20 each include a rim portion 72 at a radially outermost portion of the outer radial portion 70, a circumferential portion 73, which is proximate to but displaced from the rim portion 72, and radially oriented spokes 74. In accordance with embodiments, the rim portion 72 and the circumferential portion 73 may each have a substantially uniform radial width. At each annular sector 71, the rim portion 72 provides the second circumferential arc-segment edge 711 and the circumferential portion 73 provides the first circumferential arc-segment edge 710. The radially oriented spokes 74 extend radially outwardly from the circumferential portion 73 to the rim portion 72 and provide the first and second radial edges 712 and 713 on opposite sides thereof.

With the configuration described above, the rim portion 72 is disposed radially outwardly from the annular sectors 71, the circumferential portion 73 is disposed radially inwardly from the annular sections 71 and the spokes 74 are disposed circumferentially between adjacent pairs of annular sectors 71.

In accordance with embodiments, each annular sector 71 may be circumferentially disposed between a pair of adjacent slots 62 and radially displaced from the pair of adjacent slots 62. By a similar token, each annular sector 71 may be disposed in circumferential alignment with a corresponding tooth 61. In this way, as noted above, there will always be a path for flux lines 80 (see FIGS. 2 and 3). In addition, the teeth 61 may each have substantially similar shapes and sizes, the annular sectors 71 may also have substantially similar shapes and sizes and the spokes 74 may have substantially similar shapes and sizes. In other words, the circumferential displacements between adjacent slots 62 may be substantially uniform and the circumferential displacements between adjacent annular sectors 71 may be substantially uniform.

When the laminations 20 are affixed adjacent to one another to form the first and second core packets 30 and 40, the teeth 61 and the annular sectors 71 of each of the laminations 20 circumferentially line up with one another. As such, the teeth 61 form axial teeth formations 90 (see FIG. 1) around which the conductive elements may be wired and the annular sectors 61 form axial vents 91 (see FIG. 1). These axial vents 91 fluidly communicate with an exterior of the stator 12 and/or the electric machine 10 and the radial vent 51 (see FIG. 1) such that coolant, such as ambient air, can flow through the radial vent 51 and the axial vents 91.

Although described above as ambient air, it is to be understood that the coolant may include other fluids as well. These other fluids may include, for example, ambient air, nitrogen gas and/or hydrogen gas.

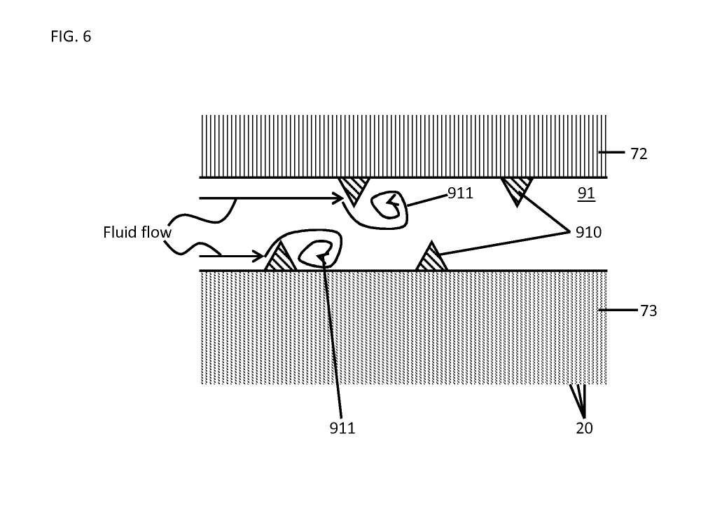

In accordance with further embodiments of the application and, with reference to FIG. 6, it will be understood that the axial vents 91 can be formed to permit laminar fluid flow therein or turbulent fluid flow therein. In the latter case, for example, the axial vents 91 can include turbulators 910 or other aerodynamic features that cause fluid flow with the axial vents 91 to become turbulent or form vortices 911 leading to increased heat removal from the surrounding material. The turbulators 910 can be formed from the laminations 20 themselves or as inserts to be inserted into the axial vents 91 following the stacking of the laminations 20.

In accordance with further aspects, a configuration or geometry of a cross-sectional shape of the annular sectors 71 may be determined by way of a finite element analysis (FEA) or another similar analytical algorithm.

In accordance with further embodiments, an amount of fluid flow through the axial vents 91 may be substantially similar to the amount of fluid flow through the radial vent 51. In this way, continued fluid flow through the electric machine 10 as a whole may be achieved without the risk of backflows or other similar issues. Thus, a size of each of the axial vents 91 may be provided such that the total amount of cross-sectional area through all of the axial vents 91 permits the substantially similar amount of fluid flow between the axial vents 91 and the radial vent 51.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A stator of an electric machine, comprising:
laminations arranged to form a core packet, each lamination being formed to define an annular array of teeth at an inner radial portion thereof and an annular array of annular sectors at an outer radial portion thereof.

2. The stator according to claim 1, wherein each lamination comprises a ring defined radially outwardly from the annular array of annular sectors.

3. The stator according to claim 1, wherein each annular sector is circumferentially disposed between a pair of adjacent slots and is radially displaced from the pair of adjacent slots.

4. The stator according to claim 3, wherein the teeth have uniform shapes and sizes and the annular sectors have uniform sizes and shapes.

5. The stator according to claim 4, wherein the annular sectors are each separated from adjacent annular sectors by a uniform distance.

6. The stator according to claim 1, wherein each annular sector comprises:
first and second parallel arc-segment edges; and
first and second radial edges connecting complementary ends of the first and second parallel arc-segment edges.

7. The stator according to claim 1, wherein each annular sector comprises a rounded corner.

8. A stator of an electric machine, comprising:
a stator core defining a bore in which a rotor is rotatably supportable, the stator core comprising:
laminations arranged to form a core packet, each lamination comprising:
an annular array of teeth at an inner radial portion thereof, the annular array of teeth defining an annular array of slots; and
an annular array of spokes at an outer radial portion thereof, the annular array of spokes defining an annular array of annular sectors.

9. The stator according to claim 8, wherein each lamination comprises a ring coupled to distal ends of the spokes.

10. The stator according to claim 9, wherein each annular sector is delimited by:
first and second parallel arc-segment edges of a central portion of the lamination and the ring; and
first and second radial edges of the corresponding spokes connecting complementary ends of the first and second parallel arc-segment edges.

11. The stator according to claim 8, wherein each annular sector is circumferentially disposed between a pair of adjacent slots and is radially displaced from the air of adjacent slots.

12. The stator according to claim 11, wherein the teeth have uniform shapes and sizes, the spokes have uniform shapes and sizes and the annular sectors have uniform sizes and shapes.

13. The stator according to claim 8, wherein each annular sector is a crowned-trapezoidal shape.

14. The stator according to claim 8, wherein each annular sector comprises a rounded corner.

15. An electric machine, comprising:
a rotor;
a stator defining a bore in which the rotor is rotatably supportable and operable in a motor or generator mode, the stator comprising:
laminations respectively affixed adjacent to at least one or two adjacent laminations to form a core packet, each lamination being formed to define an annular array of teeth at an inner radial portion thereof and an annular array of annular sectors at an outer radial portion thereof.

16. The electric machine according to claim 15, further comprising a plurality of conductive elements operably disposed between the teeth.

17. The electric machine according to claim 15, wherein each annular sector comprises:
first and second parallel arc-segment edges; and
first and second radial edges connecting complementary ends of the first and second parallel arc-segment edges.

18. The electric machine according to claim 15, wherein each annular sector is circumferentially disposed in alignment with a corresponding tooth and is radially displaced from the corresponding tooth.

19. The electric machine according to claim 15, wherein the teeth have uniform shapes and sizes and the annular sectors have uniform sizes and shapes.

20. The stator according to claim 8, wherein each annular sector is a crowned-trapezoidal shape.
